(19) United States
(12) Patent Application Publication
(10) Pub. No.: US 2024/0370119 A1
(43) Pub. Date: Nov. 7, 2024

(54) CONTROL METHOD OF A TOUCHPAD

(71) Applicant: ELAN MICROELECTRONICS CORPORATION, Hsinchu (TW)

(72) Inventors: Ying-Jie LIU, Zhubei City (TW); Hsueh-Wei YANG, Zhubei City (TW)

(73) Assignee: ELAN MICROELECTRONICS CORPORATION, Hsinchu (TW)

(21) Appl. No.: 18/639,772

(22) Filed: Apr. 18, 2024

(30) Foreign Application Priority Data
May 2, 2023 (TW) 112116345

(51) Int. Cl. G06F 3/041; G06F 3/0354; G06F 3/044

(52) U.S. Cl. CPC G06F 3/0418; G06F 3/03547; G06F 3/044; G06F 2203/04104; G06F 2203/04105

(57) ABSTRACT

A control method of a touch pad is provided. The touchpad is designed to avoid misjudging a right-click command when the default conditions are met by not reporting information about a non-specific object, thereby preventing the electronic device from mistakenly interpreting a right-click command triggered by the user when multiple objects contact with the touchpad. As a result, the user is not interrupted by an unintentional right-click command during operation, thus improving the user experience.

### CROSS-REFERENCE TO RELATED APPLICATIONS

This application is based upon and claims priority under 35 U.S.C. 119 from Taiwan Patent Application No. 112116345 filed on May 5, 2023, which is hereby specifically incorporated herein by this reference thereto.

### BACKGROUND OF THE INVENTION

### 1. Field of the Invention

The present invention relates to a touchpad, especially to a control method of a touch pad.

### 2. Description of the Prior Arts

The touchpad is currently widely used as an input interface in mobile electronic devices. By detecting the position of the user's touch objects such as fingers or a stylus on the touchpad, along with information on contact position, contact duration, movement speed, and other factors, it determines the touch events desired, subsequently executing corresponding commands as intended by the user. Initially, touch events were simple single-finger actions like tapping, dragging, and so on. However, over time, multi-touch gestures have been introduced as touch events, allowing more complex commands such as zooming, scrolling, rotating, and others to be executed.

However, multi-touch gestures may sometimes be unintentionally triggered by users. For instance, an example is the functionality on a touchpad that corresponds to the right-click function of a mouse through a two-finger tap when a mouse is not readily accessible. In the case of using mobile electronic devices, users often rest their palms on the edges of the device, leading to scenarios where the palm inadvertently touches the touchpad. When a user's palm is resting on the touchpad while simultaneously attempting to trigger the left-click function using another finger, the touchpad registers two objects (the resting palm and the pressing finger). Consequently, the touchpad might misinterpret this scenario as an attempt to trigger the right-click function. This misunderstanding contradicts the user's intent to execute the left-click function. Such misinterpretations can cause the electronic device to execute the right-click function, typically used to open menus and interrupt the ongoing function of the mobile device. This significantly impacts the user experience.

To overcome the shortcomings, the present invention provides a control method of a touch pad to mitigate or to obviate the aforementioned problems.

### SUMMARY

To achieve the main objective of the present invention, a control method of a touch pad is provided.

A control method of a touch pad comprising steps of: a. determining whether a first object and a second object contact with the touchpad; b. when the first object and the second object are determined as contacting with the touchpad, further determining whether the first object is a specific object and determining whether a pressing operation is triggered; and c. reporting a touch information sensed by the touchpad without the information of the first object when the first object is determined as the specific object and the pressing operation is triggered.

The advantage of the present invention lies in avoiding system misinterpretation of a two-finger press as a trigger for the right-click command by not reporting information about the first object under default conditions. This enhances the smoothness of user operations during the interaction process.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a touchpad in use, as applied in the present invention;

FIG. 2 is a flow chart of a first embodiment of a control method in accordance with the present invention;

FIG. 3 is a flow chart of a second embodiment of a control method in accordance with the present invention;

FIG. 4 is a flow chart of a third embodiment of a control method in accordance with the present invention;

FIG. 5 is a flow chart of a fourth embodiment of a control method in accordance with the present invention;

FIG. 6 is a flow chart of a fifth embodiment of a control method in accordance with the present invention;

FIG. 7 is a flow chart of a sixth embodiment of a control method in accordance with the present invention; and

FIG. 8 is an operational perspective of the touchpad in use, as applied in the present invention.

### DETAILED DESCRIPTION OF THE EMBODIMENTS

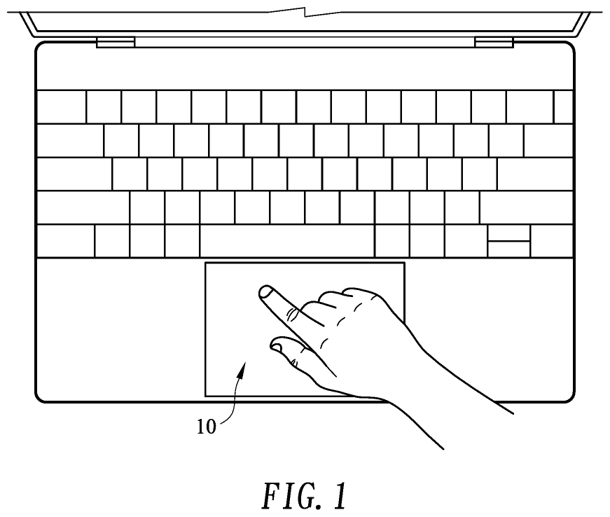

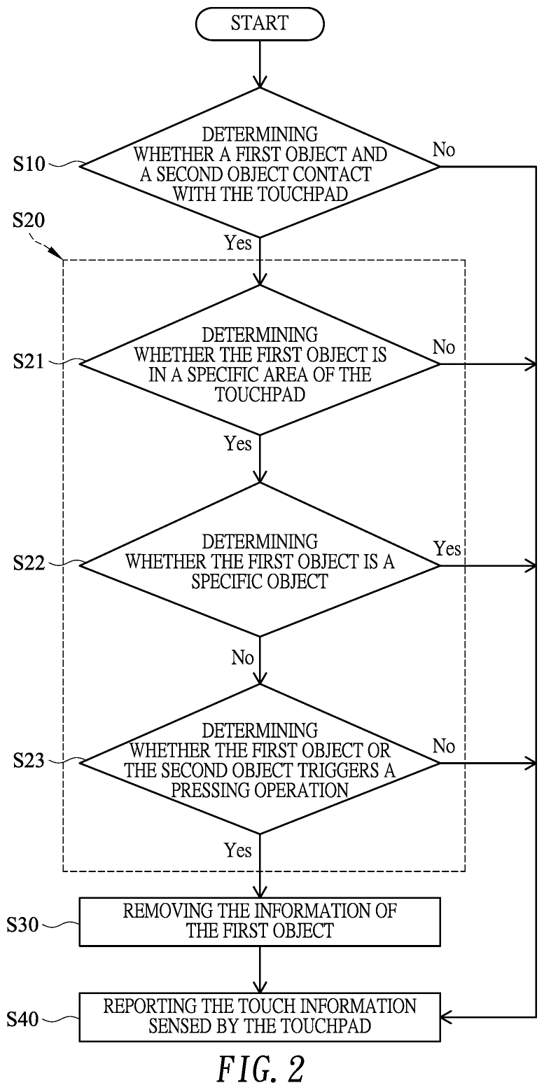

With reference to FIGS. 1 and 2, when a user touches a touchpad 10, a control method of the touchpad 10 in accordance with the present invention is executed. The control method comprises the following steps: determining whether a first object and a second object contact with the touchpad (S10); if so, determining whether a preset condition is met (S20); if yes, then removing the information of the first object (S30) and reporting the touch information sensed by the touchpad 10 to the operating system of a host or a processing unit (S40). Since when there are two objects on the touchpad 10 and the touchpad 10 is triggered by a pressing operation, it will be determined that the user intends to trigger a right-click command. However, if one of the objects is a stationary resting object, such as a palm, it may mistakenly trigger the right-click command. Therefore, the default conditions in step S20 are used to exclude this type of false triggering state. In one embodiment, the information of the first object may include the position and type of the first object. Furthermore, in one embodiment, in the case of a dual-objects pressing triggering a right-click command, it is required that the position of one object must be in a specific area of the touchpad. However, if the object in the specific area is a stationary resting object, it will also mistakenly trigger the right-click command. Therefore, the default conditions in step S20 can simultaneously determine whether a specific object is located in the specific area.

The step S20 has multiple embodiments. The following describes the presentation of the present invention based on different embodiments of step S20, but the present invention is not limited thereto.

### First Embodiment

With reference to FIGS. 1 and 2, firstly, determining whether a first object and a second object contact with the touchpad 10 (S10) means whether at least two objects contact with the touchpad 10. If it is determined that no object contacts or only a single object contacts with the touchpad 10, then execute the step S40 to report the touch information sensed by the touchpad 10, such as reporting no object (or not reporting due to the absence of objects) or reporting the touch information of the single object.

If it is determined that the first object and the second object contact with the touchpad 10, then the step S20 is executed. In this embodiment, the step S20 sequentially includes: determining whether the first object is in a specific area of the touchpad 10 (S21), determining whether the first object is a specific object (S22), and determining whether the first object or the second object triggers a pressing operation (S23).

If step S21 is determined to be false, then the step S40 is executed to report the touch information sensed by the touchpad 10, such as reporting the position information of the first and second objects. If the step S21 is determined to be true, then the step S22 is further executed.

If the step S22 is determined to be true, then the step S40 is executed to report the touch information sensed by the touchpad 10, such as reporting the position information of the first and second objects, and/or indicating that the first object is a finger or a stylus, etc. If the step S22 is determined to be false, then the step S23 is further executed.

If the step S23 is determined to be false, then the step S40 is executed to report the touch information sensed by the touchpad 10, such as reporting the position information of the first and second objects, and/or indicating that the first object is a palm, and/or providing the pressure information of the first and/or second objects. If the step S23 is determined to be true, then first the step S30 is executed to remove the information of the first object, and then the step S40 is executed to report the position of the second object and the touch information indicating that the pressing operation has been triggered.

### Second Embodiment

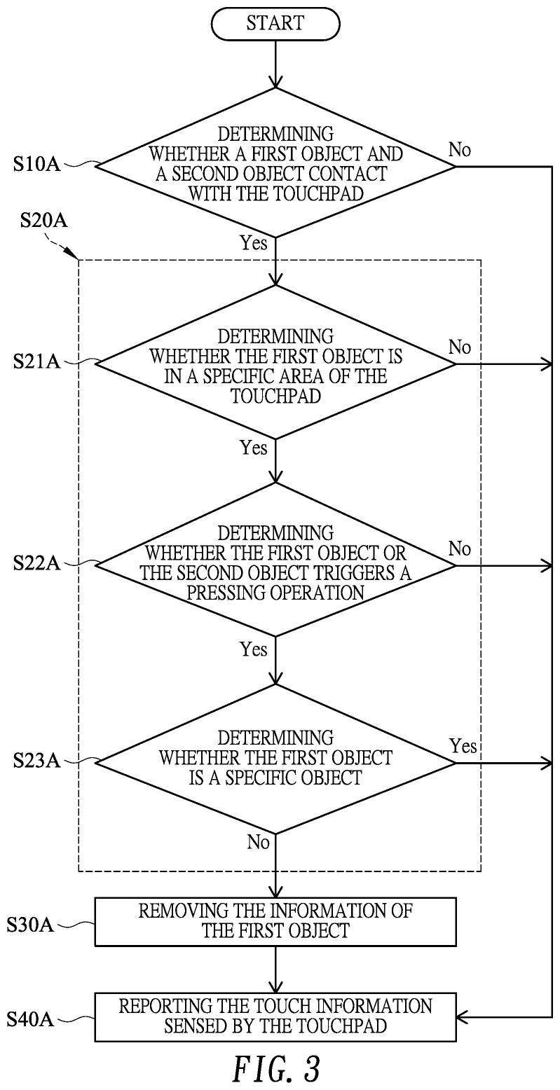

With reference to FIGS. 1 and 3, firstly, whether a first object and a second object contact with the touchpad 10 (S10A) is determined. If it is determined that no object contacts or only a single object contacts the touchpad 10, then the step S40A is executed to report the touch information sensed by the touchpad 10. If it is determined that both the first object and the second object contact the touchpad 10, the step S20A is executed. In this embodiment, the step S20A sequentially includes: determining whether the first object is in a specific area of the touchpad 10 (S21A), determining whether the first object or the second object triggers a pressing operation (S22A), and determining whether the first object is a specific object (S23A).

If the step S21A is determined to be false, then the step S40A is executed to report the touch information sensed by the touchpad 10, such as reporting the position information of the first and second objects. If the step S21A is determined to be true, the step S22A is further executed.

If the step S22A is determined to be false, then the step S40A is executed to report the touch information sensed by the touchpad 10, such as reporting the position information of the first and second objects, and/or the pressure information of the first and/or second objects. If the step S22A is determined to be true, the step S23A is further executed.

If the step S23A is determined to be true, the step S40A is executed to report the touch information sensed by the touchpad 10, such as reporting the position information of the first and second objects, and/or the pressure information of the first and/or second objects, and/or indicating that the first object is a finger or a stylus, etc. If the step S23A is determined to be false, first the step S30A is executed to remove the information of the first object, and then the step S40A is executed to report the position of the second object and the information indicating that the pressing operation has been triggered.

### Third Embodiment

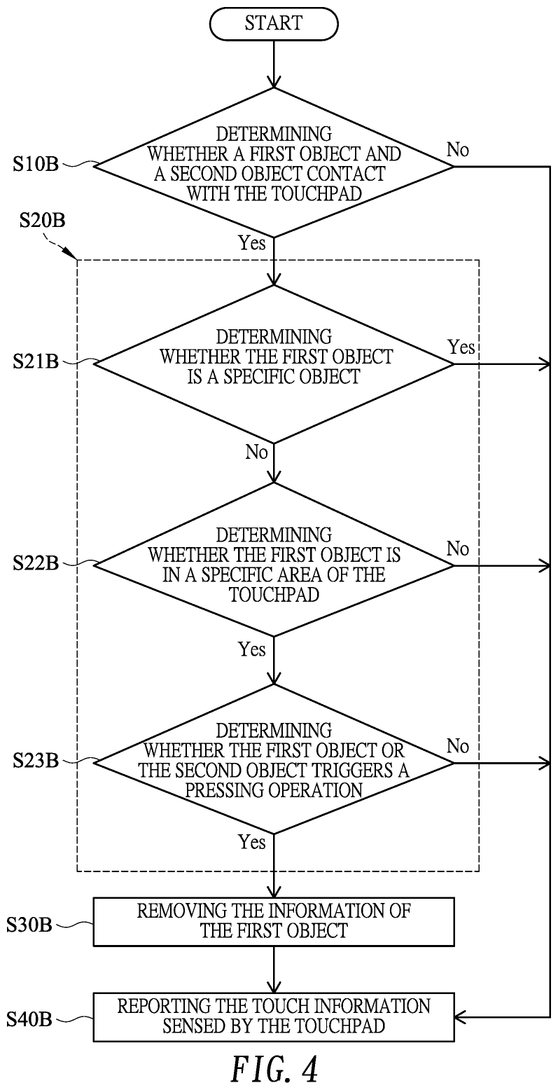

With reference to FIGS. 1 and 4, firstly, whether a first object and a second object contact with the touchpad 10 (S10B) is determined. If it is determined that no object contacts or only a single object contacts the touchpad 10, then the step S40B is executed to report the touch information sensed by the touchpad 10. If it is determined that both the first object and the second object contact the touchpad 10, the step S20B is executed. In this embodiment, the step S20B sequentially includes: determining whether the first object is a specific object (S21B), determining whether the first object is in a specific area of the touchpad 10 (S22B), and determining whether the first object or the second object triggers a pressing operation (S23B).

If the step S21B is determined to be true, then the step S40B is executed to report the touch information sensed by the touchpad 10, such as reporting the position information of the first and second objects, and/or indicating that the first object is a finger or a stylus, etc. If the step S21B is determined to be false, the step S22B is further executed.

If the step S22B is determined to be false, then the step S40B is executed to report the touch information sensed by the touchpad 10, such as reporting the position information of the first and second objects, and/or indicating that the first object is a palm, etc. If the step S22B is determined to be true, the step S23B is further executed.

If the step S23B is determined to be false, the step S40B is executed to report the touch information sensed by the touchpad 10, such as reporting the position information of the first and second objects, and/or indicating that the first object is a palm, and/or providing the pressure information of the first and/or second objects, etc. If the step S23B is determined to be true, first the step S30B is executed to remove the information of the first object, and then the step S40B is executed to report the position of the second object and the information indicating that the pressing operation has been triggered.

### Fourth Embodiment

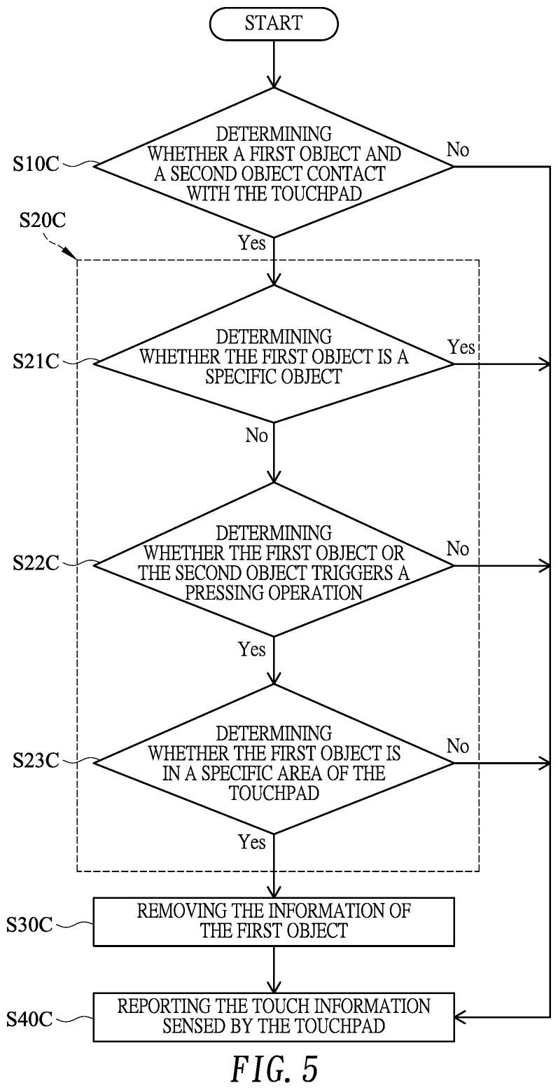

With reference to FIGS. 1 and 5, firstly, whether a first object and a second object contact the touchpad 10 (S10C) is determined. If it is determined that no object contacts or only a single object contacts the touchpad 10, then the step S40C is executed to report the touch information sensed by the touchpad 10. If it is determined that both the first object and the second object contact the touchpad 10, the step S20C is entered. In this embodiment, the step S20C sequentially includes: determining whether the first object is a specific object (S21C), determining whether the first object or the second object triggers a pressing operation (S22C), and determining whether the first object is in a specific area of the touchpad 10 (S23C).

If the step S21C is determined to be true, the step S40C is executed to report the touch information sensed by the touchpad 10, such as reporting the position information of the first and second objects, and/or indicating that the first object is a finger or a stylus, etc.

If the step S21C is determined to be false, then the step S22C is executed. If the step S22C is determined to be false, the step S40C is executed to report the touch information sensed by the touchpad 10, such as reporting the position information of the first and second objects, and/or indicating that the first object is a palm, etc. If the step S22C is determined to be true, the step S23C is further executed.

If the step S23C is determined to be false, the step S40C is executed to report the touch information sensed by the touchpad 10, such as reporting the position information of the first and second objects, and/or indicating that the first object is a palm, and/or providing the pressure information of the first and/or second objects, etc. If step S23C is determined to be true, first the step S30C is executed to remove the information of the first object, and then the step S40C is executed to report the position of the second object and the information indicating that the pressing operation has been triggered.

### Fifth Embodiment

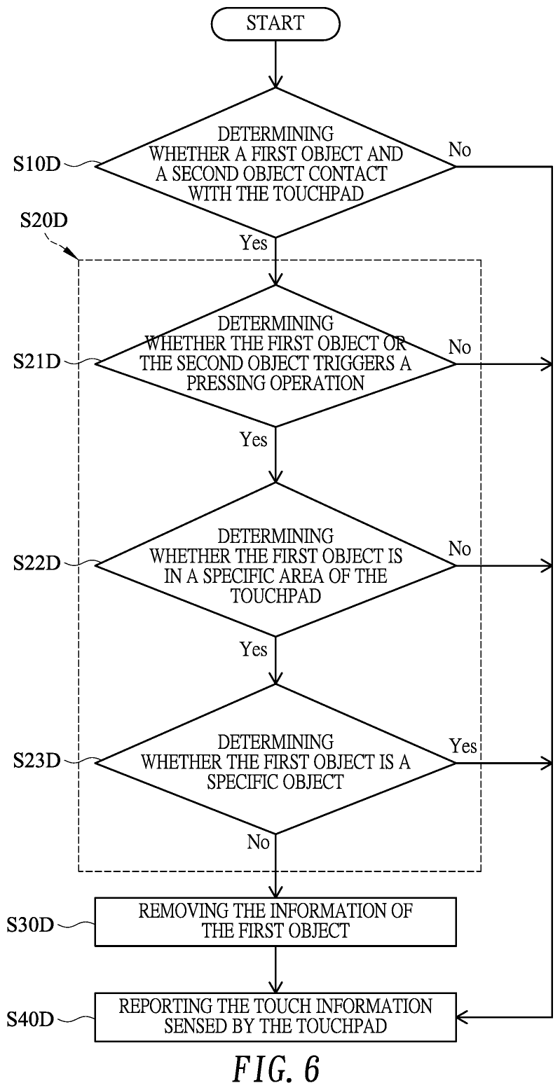

With reference to FIGS. 1 and 6, firstly, whether a first object and a second object contact the touchpad 10 (S10D) is determined. If it is determined that no object contacts or only a single object contacts the touchpad 10, then the step S40D is executed to report the touch information sensed by the touchpad 10. If it is determined that both the first object and the second object contact the touchpad 10, the step S20D is entered. In this embodiment, the step S20D sequentially includes: determining whether the first object or the second object triggers a pressing operation (S21D), determining whether the first object is in a specific area of the touchpad 10 (S22D), and determining whether the first object is a specific object (S23D).

If the step S21D is determined to be false, the step S40D is executed to report the touch information sensed by the touchpad 10, such as reporting the position information of the first and second objects, and/or providing the pressure information of the first and/or second objects, etc. If the step S21D is determined to be true, the step S22D is further executed.

If the step S22D is determined to be false, the step S40D is executed to report the touch information sensed by the touchpad 10, such as reporting the position information of the first and second objects, and/or providing the pressure information of the first and/or second objects, etc. If the step S22D is determined to be true, the step S23D is further executed.

If the step S23D is determined to be true, the step S40D is executed to report the touch information sensed by the touchpad 10, such as reporting the position information of the first and second objects, and/or providing the pressure information of the first and/or second objects, and/or indicating that the first object is a finger or a stylus, etc. If the step S23D is determined to be false, first the step S30D is executed to remove the information of the first object, and then the step S40D is executed to report the position of the second object and the information indicating that the pressing operation has been triggered.

### Sixth Embodiment

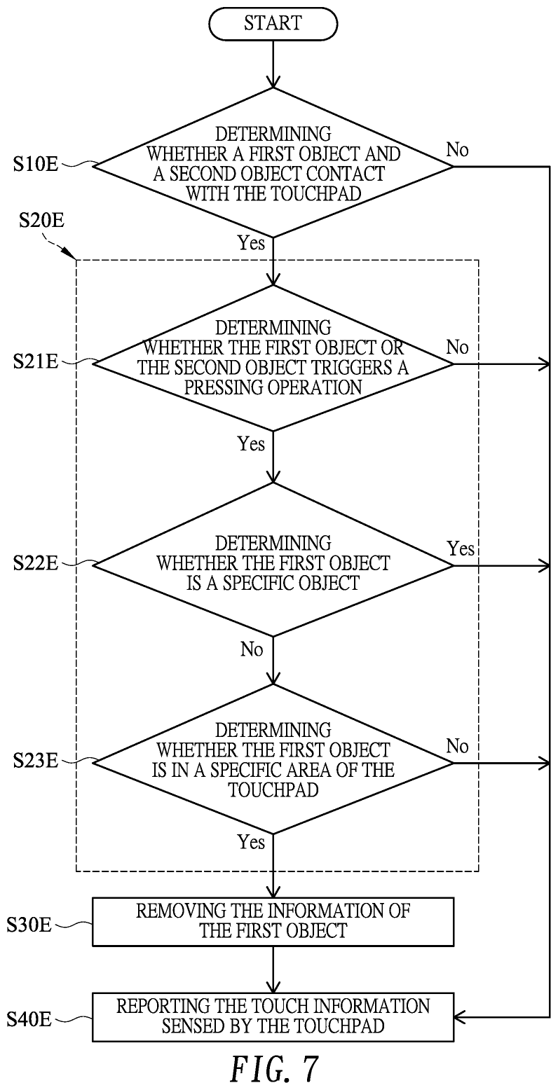

With reference to FIGS. 1 and 7, firstly, whether the first object and the second object contact the touchpad 10 (S10E) is executed. If it is determined that no object contacts or only a single object contacts the touchpad 10, then the step S40E is executed to report the touch information sensed by the touchpad 10. If it is determined that both the first object and the second object contact the touchpad 10, the step S20E is entered. In this embodiment, the step S20E sequentially includes: determining whether the first object or the second object triggers a pressing operation (S21E), determining whether the first object is a specific object (S22E), and determining whether the first object is in a specific area of the touchpad 10 (S23E).

If the step S21E is determined to be false, the step S40E is executed to report the touch information sensed by the touchpad 10, such as reporting the position information of the first and second objects, and/or providing the pressure information of the first and/or second objects, etc. If the step S21E is determined to be true, the step S22E is further executed.

If the step S22E is determined to be false, the step S40E is executed to report the touch information sensed by the touchpad 10, such as reporting the position information of the first and second objects, and/or providing the pressure information of the first and/or second objects, and/or indicating that the first object is a finger or a stylus, etc. If the step S22E is determined to be true, the step S23E is further executed.

If the step S23E is determined to be false, the step S40E is executed to report the touch information sensed by the touchpad 10, such as reporting the position information of the first and second objects, and/or providing the pressure information of the first and/or second objects, and/or indicating that the first object is a palm, etc. If the step S23E is determined to be true, first the step S30E is executed to remove the information of the first object, and then the step S40E is executed to report the position of the second object and the information indicating that the pressing operation has been triggered.

Based on the conditions determined in the step S20, when the conditions are determined that the first object is not a specific object and either the first object or the second object triggers a pressing operation, the conditions satisfy the criteria for a mistaken right-click command. At this point, the touchpad 10 removes the information of the first object and then reports it back to the configured electronic device. Consequently, the electronic device does not receive the touch information about the first object. Therefore, the received touch information from the touchpad 10 does not meet the requirements for triggering a right-click command. Through the filtering process in the step S20, the generation of mistaken right-click commands is avoided, preventing interference with the user's operations.

Furthermore, determining whether a pressing operation is triggered depends on the type of the touchpad 10. In one embodiment, a physical button is positioned beneath the touchpad 10 or at a specific location. When an object presses down on the touchpad 10 or the specific location, causing the physical button to be activated, it is determined that the pressing operation has been triggered. In another embodiment, the touchpad 10 is equipped with at least one force-sensing electrode to detect the downward force of an object. The determination of whether a pressing operation has been triggered relies on the downward force applied by the object. When the detected downward force of the object exceeds a threshold, it is concluded that the pressing operation has been triggered. Regarding the implementation pattern of using force-sensing information to determine whether a pressing operation is triggered, the touchpad 10 receives force-sensing information. Therefore, the reported touch information after determining whether a pressing operation has been triggered may include the force-sensing information.

Furthermore, determining whether the first object is a specific object involves assessing whether the first object is not an object intended to be excluded by the present invention, such as fingers or styluses, which are objects that the present invention does not aim to exclude. All other objects may be classified as objects to be excluded, such as palms, etc. The method of determination is as follows, but not limited thereto.

In one embodiment, the type of object may be determined based on the sensing area. When an object approaches or contacts with the touchpad 10, the sensing area is determined by the amount of capacitance change. The fewer adjacent electrode units that detect capacitance change exceeding a recognition threshold, the smaller the sensing area. Conversely, the more adjacent electrode units that detect capacitance change exceeding the recognition threshold, the larger the sensing area. Since the fingertip area and stylus tip area are often smaller than the palm area, it can be determined that an object with a smaller sensing area is a finger or stylus, while an object with a larger sensing area is a palm. In one embodiment, a sensing area threshold value is set. When the sensing area is smaller than the sensing area threshold, the object is determined to be a finger or stylus. When the sensing area is larger than the sensing area threshold, it is determined to be a palm.

In one embodiment, the type of object may be determined based on the difference in sensing values of the electrode units. When an object approaches or contacts with the touchpad 10, corresponding to the position of the object, the electrode units generate a maximum sensing value and multiple surrounding sensing values of adjacent sensing positions. The difference between the maximum sensing value and the surrounding sensing values is calculated. If the difference exceeds a preset value, the object is determined to be a finger or stylus. If it is less than a preset value, the object is determined to be a palm. The difference may be expressed as a numerical difference or ratio. For example, if the numerical difference between the maximum sensing value and the surrounding sensing values is greater than the preset value, the object is determined to be a finger or stylus. If the difference is less than the preset value, it is determined to be a palm. Similarly, if the ratio between the maximum sensing value and the surrounding sensing values is greater than the preset value, the object is determined to be a finger or stylus, and if the ratio is less than the preset value, it is determined to be a palm.

In one embodiment, the type of object may be determined based on the sum of sensing values of the electrode units. When an object approaches or contacts with the touchpad 10, corresponding to the position of the object, the electrode units generate a maximum sensing value and multiple surrounding sensing values of adjacent sensing positions. The sum of the maximum sensing value and the surrounding sensing values is calculated. If the sum is greater than a preset value, the object is determined to be a palm. If it is less than a preset value, the object is determined to be a finger or stylus.

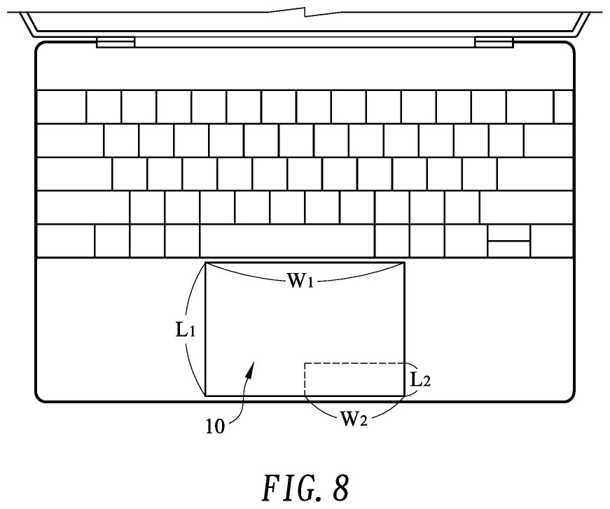

With reference to FIG. 8, the traditional touchpads often having a physical button for triggering the right-click command placed in the lower right corner of the touchpad to accommodate users' habits. Thus, in one embodiment, a specific area of the touchpad 10 corresponds to the typical right-click area. This specific area refers to the position in the lower right corner of the touchpad 10. The width W2 of this specific area along a horizontal axis is less than or equal to half of the width W1 of the touchpad 10, and the length L2 along a vertical axis is less than or equal to one-fourth of the length L1 of the touchpad 10.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A control method of a touch pad comprising steps of:
a. determining whether a first object and a second object contact with the touchpad;
b. when the first object and the second object are determined as contacting with the touchpad, further determining whether the first object is a specific object and determining whether a pressing operation is triggered; and
c. reporting a touch information sensed by the touchpad when the first object is determined not to be the specific object and the pressing operation is triggered, wherein the touch information excludes the touch information of the first object.

2. The control method as claimed in claim 1, wherein in the step b, when a downward force of the first object or the second object exceeds a threshold, the pressing operation is determined as being triggered.

3. The control method as claimed in claim 1, wherein in the step b, when the first object or the second object activates a physical button of the touchpad, the pressing operation is determined as being triggered.

4. The control method as claimed in claim 1 further comprising a step of reporting the pressing operation and a position of the second object when the first object is determined as not being the specific object and the pressing operation is determined as being triggered in the step b.

5. The control method as claimed in claim 2 further comprising a step of reporting the pressing operation and a position of the second object when the first object is determined as not being the specific object and the pressing operation is determined as being triggered in the step b.

6. The control method as claimed in claim 3 further comprising a step of reporting the pressing operation and a position of the second object when the first object is determined as not being the specific object and the pressing operation is determined as being triggered in the step b.

7. The control method as claimed in claim 1, wherein the specific object is a stylus or a finger.

8. The control method as claimed in claim 2, wherein the specific object is a stylus or a finger.

9. The control method as claimed in claim 3, wherein the specific object is a stylus or a finger.

10. The control method as claimed in claim 1, wherein
the step b further comprises steps of determining whether the first object is located in a specific area of the touchpad; and
in the step c, the touch information sensed by the touchpad is reported without the information of the first object when the first object is determined as the specific object, the pressing operation is triggered, and the first object is determined as being located in the specific area.

11. The control method as claimed in claim 2, wherein
the step b further comprises steps of determining whether the first object is located in a specific area of the touchpad; and
in the step c, the touch information sensed by the touchpad is reported without the information of the first object when the first object is determined as the specific object, the pressing operation is triggered, and the first object is determined as being located in the specific area.

12. The control method as claimed in claim 3, wherein
the step b further comprises an act of determining whether the first object is located in a specific area of the touchpad; and
in the step c, the touch information sensed by the touchpad is reported without the information of the first object when the first object is determined as the specific object, the pressing operation is triggered, and the first object is determined as being located in the specific area.

13. The control method as claimed in claim 10, wherein the specific area of the touchpad refers to a position in a lower right corner of the touchpad, has a width along a horizontal axis less than or equal to half of a width of the touchpad, and has a length along a vertical axis less than or equal to one-fourth of a length of the touchpad.

14. The control method as claimed in claim 10, wherein in the step b, the acts are executed in a sequence of:
determining whether the first object is located in the specific area of the touchpad;
when the first object is determined as in the specific area of the touchpad, further determining whether the first object is the specific object; and
when the first object is determined as not being the specific object, further determining whether the pressing operation is triggered.

15. The control method as claimed in claim 10, wherein in the step b, the acts are executed in a sequence of:
determining whether the first object is located in the specific area of the touchpad;
when the first object is determined as in the specific area of the touchpad, further determining whether the pressing operation is triggered; and
when the pressing operation is determined as being triggered, further determining whether the first object is the specific object.

16. The control method as claimed in claim 10, wherein in the step b, the acts are executed in a sequence of:
determining whether the first object is the specific object;
when the first object is determined as not being the specific object, further determining whether the first object is located in the specific area of the touchpad; and
when the first object is determined as in the specific area of the touchpad, further determining whether the pressing operation is triggered.

17. The control method as claimed in claim 10, wherein in the step b, the acts are executed in a sequence of:
determining whether the first object is the specific object;
when the first object is determined as not being the specific object, further determining whether the pressing operation is triggered; and
when the pressing operation is determined as being triggered, further determining whether the first object is located in the specific area of the touchpad.

18. The control method as claimed in claim 10, wherein in the step b, the acts are executed in a sequence of:
determining whether the pressing operation is triggered;
when the pressing operation is determined as being triggered, further determining whether the first object is located in the specific area of the touchpad; and
when the first object is determined as in the specific area of the touchpad, further determining whether the first object is the specific object.

19. The control method as claimed in claim 10, wherein in the step b, the acts are executed in a sequence of:
determining whether the pressing operation is triggered;
when the pressing operation is determined as being triggered, further determining whether the first object is the specific object; and
when the first object is determined as not being the specific object, further determining whether the first object is located in the specific area of the touchpad.
